(19) United States
(12) Patent Application Publication
(10) Pub. No.: US 2026/0093359 A1
(43) Pub. Date: Apr. 2, 2026

(54) METHOD OF REMOVING NOISE AND TOUCH DETECTION DEVICE PERFORMING THE SAME

(71) Applicant: G2touch Co., Ltd., Seongnam-si (KR)

(72) Inventors: Ki-Hwan OH, Seongnam-si (KR); Hwa-Joo NOH, Seongnam-si (KR); Ji-Woon WON, Seongnam-si (KR); Cho-Rok JEON, Seongnam-si (KR); Shu Yang, Beijing (CN)

(21) Appl. No.: 19/326,621

(22) Filed: Sep. 11, 2025

(30) Foreign Application Priority Data
Oct. 2, 2024 (KR) 10-2024-0133508

(51) Int. Cl. G06F 3/041; G06F 3/044

(52) U.S. Cl. CPC G06F 3/0418; G06F 3/04164; G06F 3/0446

(57) ABSTRACT

A touch detection device includes a panel including a plurality of electrodes regularly arranged in a plurality of rows and columns, a multiplexer configured to be connected to electrodes corresponding to a plurality of rows for each column through a plurality of data lines, and a sensor driver configured to detect touch input applied to a specific row through a sensing voltage in a state in which a ground potential or a driving voltage having a waveform of a specific cycle is applied to rows adjacent to the specific row. A specific number of data lines is arranged in a lower region of an electrode at lower left where the sensing voltage is detected among the electrodes.

### BACKGROUND OF THE INVENTION

### Field of the Invention

The present invention relates to a method and apparatus for removing noise from a touchscreen, and more particularly to a method of removing noise to improve touch sensitivity and a touch detection device for performing the same.

### Description of the Related Art

A touch panel includes a plurality of electrodes. An object, such as a finger or stylus, changes the capacitance between electrodes included in the touch panel to provide input. For the touch panel to detect input provided by a touch object, a driver circuit needs to apply a drive signal.

In this regard, to sense touch input by the touch object in a sensing channel of a specific row and column among the plurality of electrodes, a driving voltage may be applied to a channel adjacent to the sensing channel. As the driving voltage is symmetrically applied to adjacent channels on one side and the other side of the sensing channel, parasitic capacitance values between the channels symmetrically occur. Accordingly, an electromagnetic distribution between the sensing channel and the adjacent channels is symmetrically formed, and touch sensitivity may be improved.

However, for electrodes at a corner of the touch panel, adjacent channels are disposed only on one side, and thus driving voltages are asymmetrically applied. Accordingly, an electromagnetic distribution between a sensing channel and an adjacent channel is asymmetrically formed, resulting in a problem of reduced touch sensitivity in a region adjacent to the corner.

### SUMMARY OF THE INVENTION

Therefore, the present invention has been made in view of the above problems, and it is an object of the present invention to provide a method of removing noise and a touch detection device performing the same.

It is another object of the present invention to solve a problem of reduced touch sensitivity in a region adjacent to a corner due to an asymmetric electromagnetic distribution between a sensing channel and an adjacent channel.

In accordance with the present invention, the above and other objects can be accomplished by the provision of a touch detection device configured to perform a method of removing noise, the touch detection device including a panel including a plurality of electrodes regularly arranged in a plurality of rows and columns, a multiplexer configured to be connected to electrodes corresponding to a plurality of rows for each column through a plurality of data lines, and a sensor driver configured to detect touch input applied to a specific row through a sensing voltage in a state in which a ground potential or a driving voltage having a waveform of a specific cycle is applied to rows adjacent to the specific row. A specific number of data lines is arranged in a lower region of an electrode at lower left where the sensing voltage is detected among the electrodes. The driving voltage or the ground potential is applied to the specific number of data lines through a compensation pattern differently from other data lines.

According to embodiments, the sensor driver may include a digital-to-analog converter (DAC) configured to convert a digital signal into an analog signal, and a repair switch configured to block electrical connection between the DAC and specific data lines when a short circuit occurs in the specific data lines. The specific number of data lines may be connected to pins of the repair switch.

According to embodiments, the sensor driver may be configured to apply the sensing voltage to the electrode at the lower left, and control the repair switch so that the driving voltage or the ground potential is applied to the specific number of data lines.

According to embodiments, the sensor driver may further include a driving voltage controller configured to apply the driving voltage to some of the specific number of data lines to form a symmetrical electromagnetic distribution based on the electrode at the lower left. The specific number of data lines may be connected to the driving voltage controller so that the driving voltage is applied to first and second lines among the specific number of data lines, and the specific number of data lines may be connected to the ground through the repair switch and the compensation pattern so that the ground potential is applied to a third line among the specific number of data lines.

According to embodiments, the specific number of data lines in the lower region of the electrode at the lower left may be set to three or five. The three or five data lines may be connected to the driving voltage controller or connected to the ground via the compensation pattern.

According to embodiments, the sensor driver may be configured to acquire data voltages converted into an analog signal form through the DAC, and connect two lines among three data lines to the driving voltage controller and perform a control operation so that a last line among the three data lines is connected to the ground through the compensation pattern when a data voltage corresponding to the electrode at the lower left is greater than or equal to a reference value.

According to embodiments, the sensor driver may be configured to acquire data voltages converted into an analog signal form through the DAC in a state in which the three data lines are connected to the driving voltage controller or the ground, and perform a control operation so that, when the data voltage corresponding to the electrode at the lower left is greater than or equal to a second reference value, two lines adjacent to the electrode at the lower left among five data lines are connected to the driving voltage controller, and three remaining lines are connected to the ground through the compensation pattern.

According to embodiments, the sensor driver may be configured to apply a sensing signal to a specific row on left as the sensing voltage and apply the sensing signal and reverse signals of a reverse phase to rows adjacent to the specific row as the driving voltage, and perform a control operation so that three or five data lines in the lower region of the electrode at the lower left are connected to the driving voltage controller or connected to the ground through the compensation pattern. The sensor driver may be configured to store reverse phase touch coordinate values and potential values at which a potential value greater than or equal a reference value is detected when the potential value greater than or equal to the reference value is detected in rows to which the reverse signals are applied, determine whether the reverse phase touch coordinate values are included in detected general touch coordinate values while changing rows to which the sensing signal is applied, and determine touch input for rows corresponding to the reverse phase touch coordinate values to be floating touch input when the reverse phase touch coordinate values are included in the general touch coordinate values.

According to embodiments, the sensor driver may be configured to apply the ground potential to remaining rows outside of the adjacent rows in a state in which the sensing signal and the reverse signals are applied, and apply a reverse voltage of a reverse phase to the specific row in a column adjacent to a column to which the sensing signal is applied and to the adjacent rows.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a drawing illustrating a touch detection device according to the present disclosure;

FIG. 2 is a drawing illustrating a detailed configuration of a sensor driver in the touch detection device according to the present disclosure;

FIG. 3 is a block diagram of the touch detection device including a plurality of electrodes arranged in a plurality of rows and columns;

FIG. 4 is an enlarged view of the plurality of electrodes arranged in the plurality of rows and columns of the touch detection device of FIG. 3;

FIGS. 5A and 5B illustrate a configuration in which a sensing voltage is applied to an electrode in a sensing channel and driving voltages are applied to electrodes in adjacent channels;

FIG. 6 illustrates voltages applied to a specific channel not at a bottom and adjacent channels in a structure in which the specific channel is sensed in a row direction;

FIGS. 7A and 7B illustrate an electromagnetic distribution formed in a sensing channel at a corner and adjacent channels around the sensing channel and voltages applied thereto;

FIG. 8 illustrates a distribution of DAC values output from a DAC as a sensing voltage is applied to each of the electrodes arranged in the plurality of rows and columns;

FIG. 9 illustrates a structure in which lines corresponding to a specific number of electrodes in a lower left part are formed in a compensation pattern;

FIG. 10 illustrates a structure of a touch panel in which a plurality of electrodes is arranged in the plurality of rows and columns;

FIG. 11 is an enlarged view of a region (A) of FIG. 10;

FIG. 12 illustrates DAC values of cells corresponding to the plurality of rows and columns on a touch panel to which the compensation pattern is added; and

FIG. 13 illustrates a structure for determining a floating touch object by applying a sensing voltage, a driving voltage in the form of a reverse signal having a reverse phase, and a ground potential to electrodes in the plurality of rows and columns.

### DETAILED DESCRIPTION OF THE INVENTION

Hereinafter, preferred embodiments of the present invention will be described in detail with reference to the attached drawings. Prior thereto, terms or words used in this specification and claims should not be construed as limited to usual or dictionary meanings, and should be interpreted as having meanings and concepts consistent with the technical idea of the present invention based on the principle that an inventor may appropriately define a concept of a term to describe the invention of the inventor in the best way possible. Therefore, the embodiments described in this specification and the configurations shown in the drawings are only one of the most preferred embodiments of the present invention and do not represent the entire technical idea of the present invention. Thus, it should be understood that, at the time of filing this application, there may be various equivalents and modifications that can replace the embodiments and configurations.

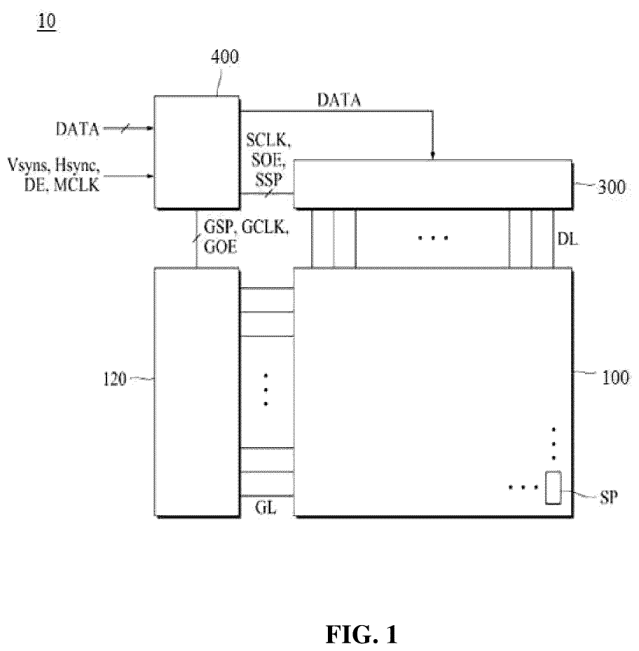

Hereinafter, a description will be given of a method of removing noise according to the present invention and a touch detection device performing the same. The touch detection device corresponds to a display device that performs a touch function and the method of removing noise from a touchscreen. In this regard, FIG. 1 is a drawing illustrating the touch detection device according to the present disclosure.

Referring to FIG. 1, the touch detection device 10 may include a display panel 100, a gate driver 120, a sensor driver (data driver) 300, and a controller 400. A plurality of gate lines GL and a plurality of data lines DL may be connected to the display panel 100. A plurality of subpixels SP may be arranged in a matrix on the display panel 100. The gate driver 120 may be configured to drive the plurality of gate lines GL. The sensor driver (data driver) 300 may be configured to supply a data voltage through the plurality of data lines DL. The controller 140 may be configured to control the sensor driver (data driver) 300.

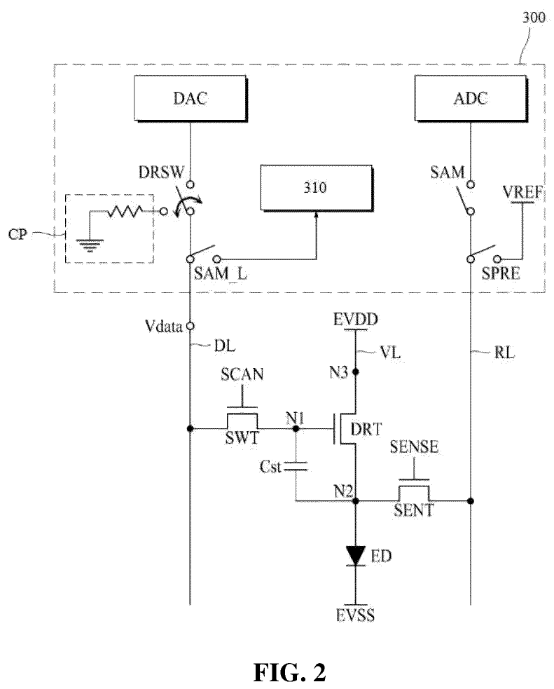

FIG. 2 is a drawing illustrating a detailed configuration of the sensor driver in the touch detection device according to the present disclosure. Referring to FIG. 2, the sensor driver 300 is connected to a first node N1 of a subpixel SP through a data line DL, and may supply a data voltage Vdata converted into an analog signal form through a digital-to-analog converter (DAC) to a data line DL. A switching transistor SWT of the subpixel SP is arranged between the data line DL and the first node N1, and may be turned on by a scan signal SCAN supplied from a gate line GL to transmit the data voltage Vdata supplied from the data line DL to the first node N1, which is a gate node of a driving transistor DRT.

The sensor driver 300 may detect whether a signal line (e.g., a data line, a reference line, a driving voltage line, etc.) arranged in the subpixel SP is defective, and may perform a line compensation function to repair a defective signal line. For example, a signal line defect may be a short circuit defect between the data line DL and another adjacent data line DL, or a short circuit defect between the data line DL and an adjacent driving voltage line VL. In addition, the sensor driver 300 may repair a data line DL in which a short circuit defect has occurred.

The sensor driver 300 may further include a driving voltage controller 310 and a compensation pattern CP to perform the line compensation function. The driving voltage controller 310 may be connected to the data line DL via a line sampling switch SAM_L. The driving voltage controller 310 may be connected to another data line DL of an adjacent subpixel. For example, the driving voltage controller 310 may be connected to adjacent data lines DL among the plurality of data lines DL.

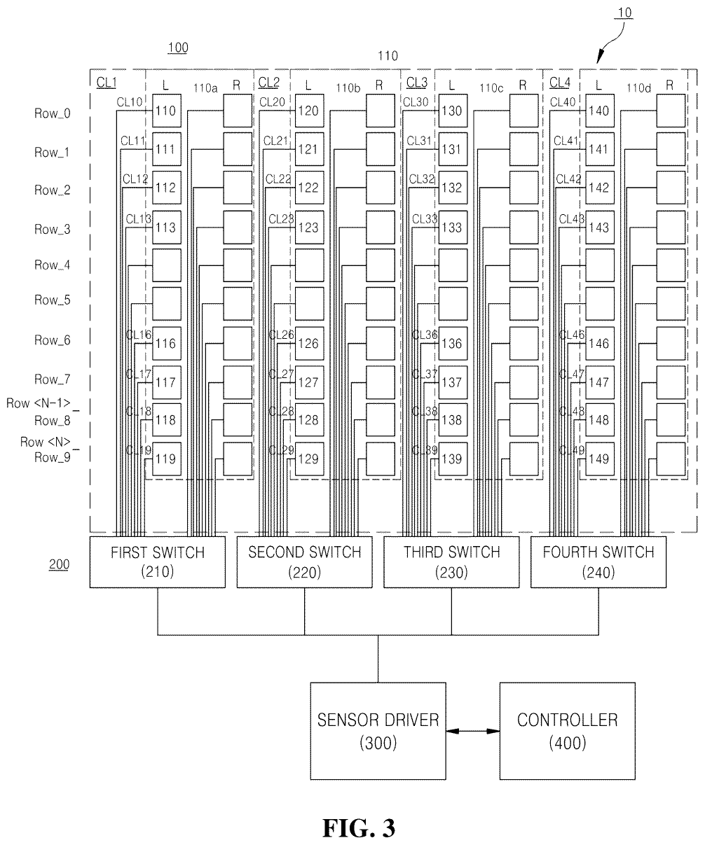

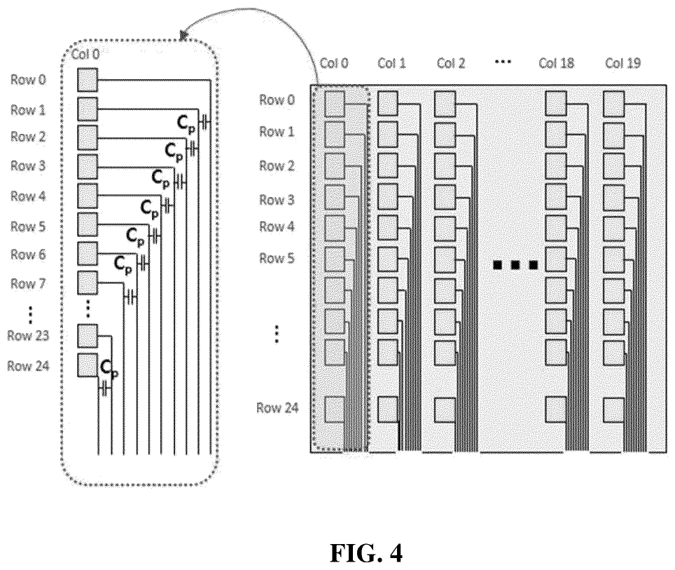

The touch detection device of FIGS. 1 and 2 may include a plurality of electrodes arranged in a plurality of rows and columns. In this regard, FIG. 3 is a block diagram of the touch detection device including the plurality of electrodes arranged in the plurality of rows and columns. FIG. 4 is an enlarged view of the plurality of electrodes arranged in the plurality of rows and columns of the touch detection device of FIG. 3.

Referring to FIG. 3, the touch detection device 10 may include a panel 100, a multiplexer 200, and a sensor driver 300. The touch detection device 10 may include the panel 100 including a plurality of electrodes regularly arranged in rows and columns, the switch 200 that electrically connects some of the electrodes to form a plurality of sensing channels 110a to 110d, and the sensor driver 300 that provides drive signals to the sensing channels 110a to 110d.

The switch 200 may be connected to electrodes 110, 120, 130, and 140 arranged in a specific column via connection lines CL1, CL2, CL3, and CL4. The sensor driver 300 may be operably coupled to the switch 200. The sensor driver 300 may perform a control operation so that a drive signal of a voltage waveform of a specific cycle is applied to the electrodes 110, 120, 130, and 140.

The connection lines CL1 in a first column may include first to tenth connection lines CL10 to CL19. The connection lines CL2 in a second column may include first to tenth connection lines CL20 to CL29. The connection lines CL3 in a third column may include first to tenth connection lines CL30 to CL39. Lengths of the connection lines CL1, CL2, CL3, and CL4 may be differently set according to positions of electrodes arranged in a specific row.

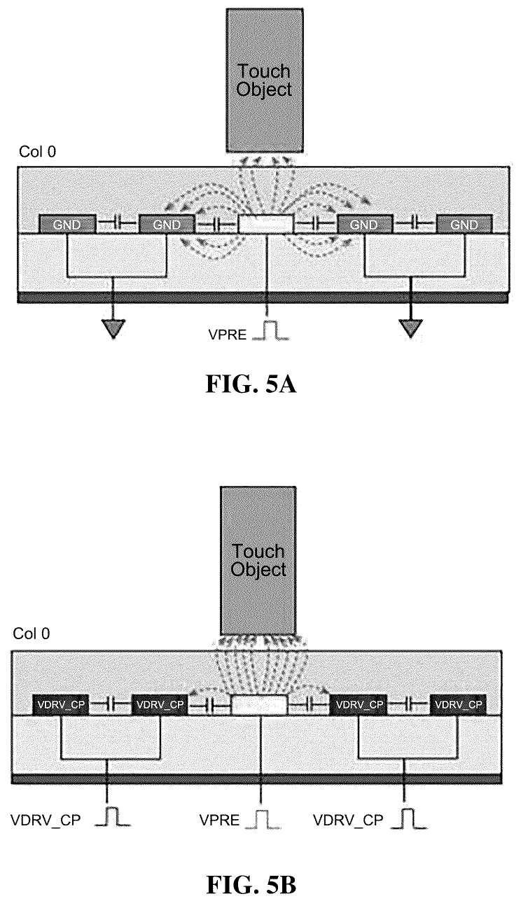

The number of a plurality of rows of electrodes is not limited to 10 and may be changed depending on the application. Referring to FIG. 4, the number of the plurality of rows and the number of columns of electrodes may be set to 25 and 20, respectively. A sensing voltage may be applied to an electrode of a sensing channel of a specific row among a plurality of rows of a specific column, and driving voltages may be applied to electrodes of adjacent channels. In this regard, FIGS. 5A and 5B illustrate a configuration in which a sensing voltage is applied to an electrode of a sensing channel and a ground potential or a driving voltage is applied to electrodes of adjacent channels.

FIG. 5A illustrates an electromagnetic distribution of the sensing channel and a surrounding region in response to application of the sensing voltage Vpre to the electrode of the sensing channel that senses the touch object and application of the ground potential to the adjacent channels. FIG. 5B illustrates an electromagnetic distribution of the sensing channel and a surrounding region in response to application of the sensing voltage Vpre to the electrode of the sensing channel that senses the touch object and application of the driving voltage Vdrv to the adjacent channels.

The method of removing noise and the touch detection device performing the same according to the present disclosure will be described with reference to FIGS. 1 to 5. In this regard, values of the sensing voltage Vpre and the driving voltage Vdrv are necessary to acquire a DAC value corresponding to a data voltage output from the DAC. By applying a signal of the sensing voltage Vpre to a cell (electrode) to be sensed to detect touch, and adding the driving voltage Vdrv to N cells on an upper part and a lower part, sensing sensitivity may be improved.

In this regard, when a drive signal of the same potential is applied to a sensor electrode corresponding to the sensing channel and the adjacent electrode, abnormal charges Q between electrodes approach 0. Therefore, an electric field of the sensor electrode may be coupled with a conductive object, such as a finger, thereby enhancing sensitivity. When the ground potential is applied to the adjacent electrode of the sensor electrode, strong coupling between the sensor electrode and the adjacent electrode reduces an electromagnetic field induced by the conductive object, such as the finger. The sensor electrode on the touch panel generates a parasitic capacitance Cp component due to a structure thereof.

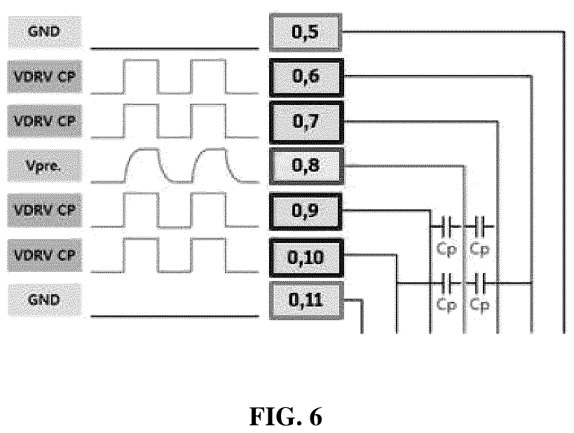

In this regard, when the sensing channel is in a row direction, and cells are not at a bottom, a voltage application structure for touch detection may be symmetrically formed. FIG. 6 illustrates voltages applied to a specific channel not at a bottom and adjacent channels in a structure in which the specific channel is sensed in the row direction. Referring to FIGS. 4 and 6, the sensing voltage Vpre may be applied to row 8 on the left, and the driving voltage Vdrv may be applied to rows 6, 7, 9, and 10 which are adjacent channels. The ground potential may be applied to rows 5 and 10 adjacent to rows 6, 7, 9, and 10 which are adjacent channels.

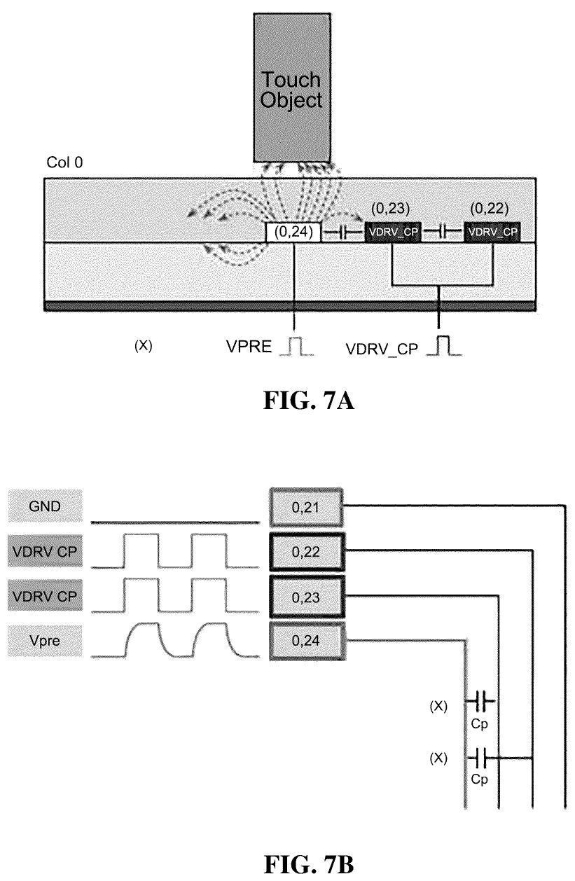

Meanwhile, when designing a touch sensor, a lowermost left cell is located at a corner of the touch panel, and thus a touch sensor is not present in an adjacent channel in the vicinity. In this regard, FIGS. 7A and 7B illustrate an electromagnetic distribution formed in a sensing channel at a corner and adjacent channels around the sensing channel and voltages applied thereto.

FIG. 7A illustrates an asymmetric electromagnetic distribution in the sensing channel and in the vicinity resulting from application of the sensing voltage Vpre to an electrode of a sensing channel that senses the touch object and application of the driving voltage Vdrv to an adjacent channel on one side. Referring to FIG. 7B, in response to application of the sensing voltage Vpre to an electrode in lowermost left row 24, a voltage is asymmetrically applied.

The driving voltage Vdrv is applied to rows 22 and 23 on an upper side adjacent to one side of lowermost left row 24. The ground potential is applied to row 21 adjacent to row 22. Therefore, an asymmetric electromagnetic distribution is formed in response to the driving voltage Vdrv being asymmetrically applied only to one side of row 24 serving as the sensing channel to which the sensing voltage Vpre.

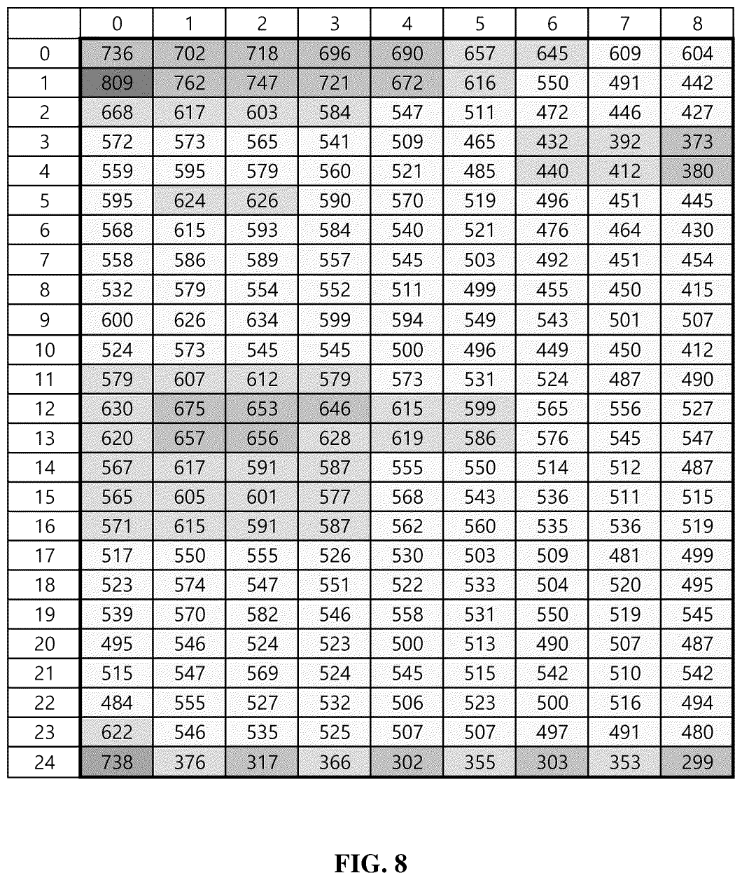

In this regard, an electromagnetic distribution due to the driving voltage Vdrv of the sensing channel at the corner of the touch panel is different from that of other cells. Therefore, a deviation occurs in a DAC value of the sensing channel having an asymmetric structure at a corner compared to a DAC value of the sensing channel having a symmetric structure. In this regard, FIG. 8 illustrates a distribution diagram of DAC values output from the DAC as the sensing voltage is applied to each electrode arranged in the plurality of rows and columns.

FIG. 8 illustrates a distribution of DAC values output from the DAC as the sensing voltage is applied to each of the electrodes arranged in the plurality of rows and columns. Referring to FIGS. 4 and 8, DAC values of electrodes of lower left row 24 and column 0 exceed a reference value. Therefore, the DAC value of the lower left cell is detected as being relatively higher than that of other cells in the same row, resulting in touch sensitivity imbalance.

Meanwhile, deviations in DAC values of the sensing channels at the corner of the touch panel is not limited to the lower left part, and may occurs at other corners. In this regard, deviations in DAC values may occurs in sensing channels at upper left, upper right, and lower right.

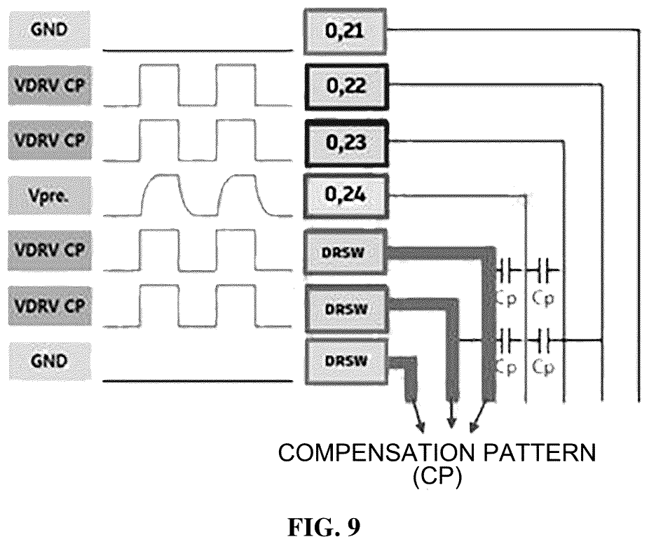

Meanwhile, a detailed description will be given of the method of removing noise and the touch detection device performing the same according to the present disclosure with reference to the drawings. In this regard, FIG. 9 illustrates a structure in which lines corresponding to a specific number of electrodes in the lower left part are formed in a compensation pattern.

Referring to FIG. 9, repair switches DRSW may be arranged in rows 25, 26, and 27 adjacent to an electrode in row 24 at lower left. The driving voltage Vdrv or the ground potential is applied to pins of the repair switches DRSW arranged in rows 25, 26, and 27 so that an additional parasitic capacitance Cp is generated between the compensation patterns CP. Accordingly, due to the parasitic capacitance Cp generated in a symmetrical structure, a symmetrical electromagnetic distribution is formed, preventing touch sensitivity imbalance and improving touch sensitivity.

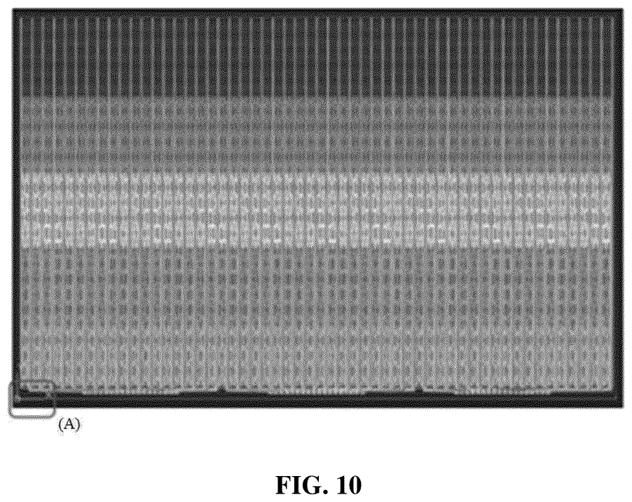

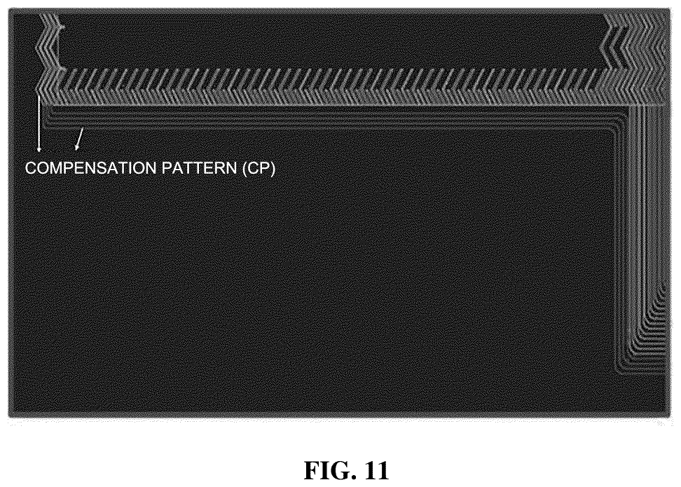

In this regard, FIG. 10 illustrates a structure of a touch panel in which a plurality of electrodes is arranged in the plurality of rows and columns. Referring to FIG. 10, a region A corresponds to a region in which compensation patterns are formed at lower left and a lower part of the lower left. FIG. 11 is an enlarged view of the region A of FIG. 10.

Referring to FIGS. 10 and 11, the compensation pattern CP is added around cells at the lower left to form a structure for surrounding fan-out junctions of up to three cells in a lower part of the cells at the lower left. To compensate for the asymmetrical electromagnetic distribution occurring in the cells at lower left, three cells may be arranged in the lower part of the cells at the lower left.

The compensation pattern CP may be directly connected to pins of TDI (Test Data In) through the repair switch DRSW. Referring to FIGS. 2 to 11, the driving voltage Vdrv or the ground potential may be applied through the repair switch DRSW. When the pins of TDI are insufficient, the compensation pattern CP may be formed in a floating state, not connected to the pins of TDI.

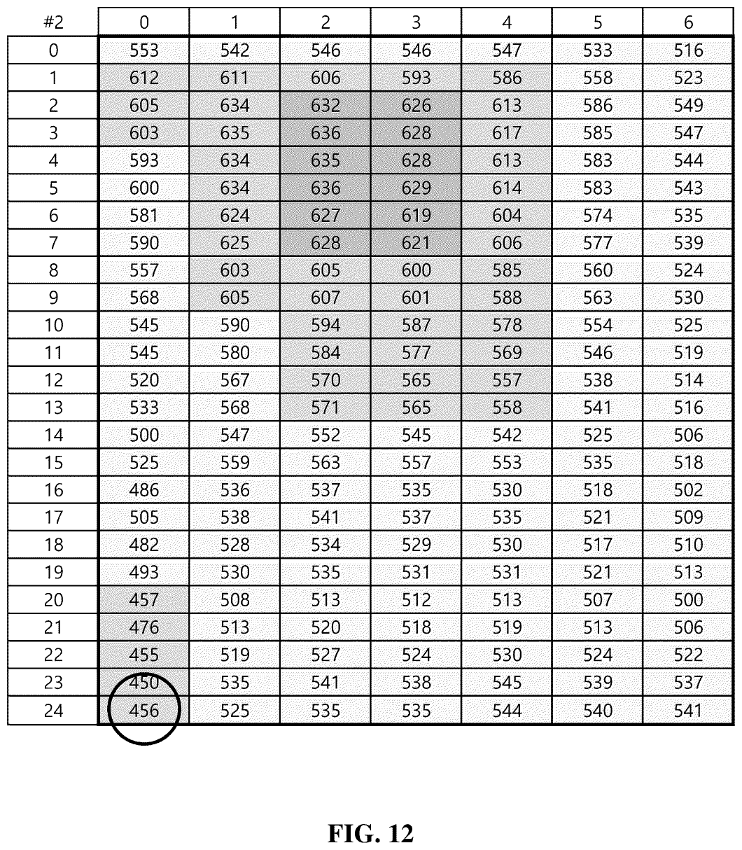

The method of removing noise and the touch detection device performing the same according to the present disclosure may prevent touch sensitivity imbalance and achieve touch sensitivity by reducing a DAC value of a cell at a corner by the compensation pattern CP. In this regard, FIG. 12 illustrates DAC values of cells corresponding to the plurality of rows and columns on the touch panel to which the compensation pattern is added. Referring to FIGS. 8 and 12, a DAC value of a cell in row 24 at the lower left is reduced from 738 to 456, and thus it is possible to prevent touch sensitivity imbalance and achieve touch sensitivity.

Hereinafter, the method of removing noise and the touch detection device performing the same, as claimed through the present invention, will be described with reference to FIGS. 1 to 12. Referring to FIGS. 1 to 12, the touch detection device 10 may include the panel 100, the multiplexer 200, and the sensor driver 300.

The panel 100 may include a plurality of electrodes regularly arranged in a plurality of rows and columns. The multiplexer 200 may be configured to be connected to electrodes corresponding to a plurality of rows for each column through a plurality of data lines DL. The sensor driver 300 may be configured to detect touch input applied to a specific row through the sensing voltage Vpre in a state in which a ground potential or a driving voltage having a waveform of a specific cycle is applied to rows adjacent to the specific row. The sensor driver 300 may control the panel 100 and the multiplexer 200 so that the sensing voltage Vpre is detected in a state in which the driving voltage or the ground potential is applied.

A specific number of data lines may be arranged in a lower region of the electrode at the lower left where the sensing voltage Vpre is detected. For example, three data lines may be arranged in a lower region of an electrode in column 0 and row 24 at the lower left. The specific number of data lines may be connected to ground through a compensation pattern CP different from the other data lines.

The sensor driver 300 may include the DAC and the repair switch DRSW. The DAC may be configured to convert a digital signal into an analog signal. The repair switch DRSW may be configured to block electrical connection between the DAC and specific data lines when a short circuit occurs in the specific data lines. The specific number of data lines in the lower region of the electrode at the lower left may be connected to pins of the repair switch DRSW.

The sensor driver 300 may apply the sensing voltage Vpre to the electrode at the lower left. The sensor driver 300 may control the repair switch DRSW so that the driving voltage Vdrv or the ground potential is applied to the specific number of data lines.

The sensor driver 300 may further include a driving voltage controller 310. The driving voltage controller 310 applies the driving voltage to some of the specific number of data lines to form a symmetrical electromagnetic distribution based on the electrode at the lower left.

It is possible to further include the driving voltage controller 310 configured to apply the driving voltage so that parasitic capacitance occurs between adjacent data lines. The specific number of data lines of the lower region of the electrode at the lower left may be connected to the driving voltage controller 310 so that the driving voltage Vdrv is applied to first and second lines among the specific number of data lines. The specific number of data lines of the lower region may be connected to the ground through the repair switch DRSW and the compensation pattern CP so that the ground potential is applied to a third line among the specific number of data lines.

The first and second lines may be arranged adjacent to the electrode in row 24 at the lower left so that the driving voltage Vdrv may be applied. The third line may be arranged adjacent to the second line to which the driving voltage Vdrv is applied so that the ground potential may be applied. The specific number of data lines in the lower region of the electrode at the lower left may be set to three or five. The three or five data lines may be connected to the driving voltage controller 310 or may be connected to the ground via the compensation pattern CP.

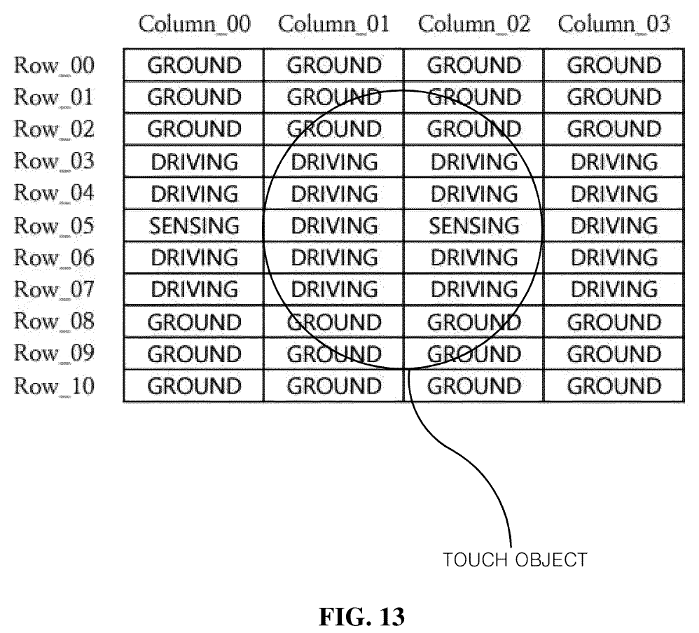

Meanwhile, the method of removing noise and the touch detection device performing the same according to the present disclosure may implement a reverse phase driving method for determining a small floating object (such as an earphone cord, a coin, or a key). In this regard, FIG. 13 illustrates a structure for determining a floating touch object by applying a sensing voltage, a driving voltage in the form of a reverse signal having a reverse phase, and a ground potential to electrodes in the plurality of rows and columns. Referring to FIGS. 1 to 13, three or five data lines are arranged in the lower region of the electrode at the lower left, so that touch sensitivity may be improved.

The method of removing noise and the touch detection device performing the same according to the present disclosure are described with reference to FIGS. 1 to 13. The sensor driver 300 may acquire data voltages converted into an analog signal form through the DAC. When a data voltage corresponding to the electrode at the lower left is greater than or equal to a reference value, the sensor driver 300 may connect two lines among the three data lines to the driving voltage controller 310. In addition, the sensor driver 300 may perform a control operation so that a last line among the three data lines is connected to ground (a ground potential is applied) through the compensation pattern CP.

The sensor driver 300 may acquire the data voltages converted into the analog signal form through the DAC in a state in which the three data lines are connected to the driving voltage controller 310 or ground. The sensor driver 300 may determine whether the data voltage corresponding to the electrode at the lower end is greater than or equal to a second reference value. The second reference value for using five data lines may be set to a value lower than a reference value for using the three data lines. Accordingly, by increasing the number of data lines of a dummy structure, the touch sensitivity imbalance may be further resolved and the touch sensitivity may be further improved.

When the data voltages are higher than the second reference value, the sensor driver 300 may connect two lines adjacent to the electrode at the lower left among the five data lines to the driving voltage controller 310. Furthermore, the sensor driver 300 may perform a control operation so that the remaining three lines among the five data lines are connected to ground via a compensation pattern CP.

The sensor driver 300 may apply a sensing signal as a sensing voltage to a specific row on the left, and apply a sensing signal and reverse signals of a reverse phase to rows adjacent to the specific row as the driving voltage. The sensor driver 300 may connect three or five data lines in the lower region of the electrode at the lower left to the driving voltage controller 310 or to ground via the compensation pattern CP. By utilizing dummy data lines, touch sensitivity imbalance may be resolved and touch sensitivity may be improved, enabling more accurate determination of subsequent floating touch input.

By utilizing three or five data lines in the lower region of the electrode at the lower left, the sensor driver 300 may more accurately determine floating touch input in a state in which the touch sensitivity imbalance is resolved. When a potential value greater than or equal to a reference value is detected in rows to which reverse signals are applied, the sensor driver 300 may store reverse phase touch coordinate values and potential values at which the potential value greater than or equal to the reference value is detected. The sensor driver 300 may determine whether the reverse phase touch coordinate values are included in detected general touch coordinate values while changing rows to which the sensing signal is applied. When the reverse phase touch coordinate values are included in the general touch coordinate values, the sensor driver 300 may determine touch input for rows corresponding to the reverse phase touch coordinate values to be floating touch input.

To accurately detect floating touch input, drive signals may be applied to adjacent channels in adjacent rows and columns so as to surround a sensing channel to which a sensing signal is applied, as shown in FIG. 13. The sensor driver 300 may apply a ground potential to the remaining rows outside of the adjacent rows in a state in which the sensing signal and the reverse signals are applied. The sensor driver 300 may apply a reverse voltage of a reverse phase to the specific row in a column adjacent to a column to which the sensing signal is applied and to the adjacent rows.

The method of removing noise and the touch detection device performing the same according to the present invention has been described. The technical effects of the method of removing noise and the touch detection device performing the same may be summarized as follows, but are not limited thereto.

According to the present invention, it is possible to provide the method of removing noise and the touch detection device performing the same by forming a compensation pattern adjacent to an electrode at a corner.

According to the present invention, it is possible to improve touch sensitivity by arranging three or five data lines in a lower region of an electrode at the lower left.

According to the present invention, it is possible to further resolve touch sensitivity imbalance and further improve touch sensitivity by increasing the number of data lines of a dummy structure.

According to the present invention, it is possible to resolve touch sensitivity imbalance and improve touch sensitivity in a state in which touch sensitivity imbalance is resolved through data lines of a dummy structure to which a compensation pattern is applied, enabling more accurate determination of subsequent floating touch input.

Even though the present invention has been described above in relation to specific embodiments of the present invention, this is only an example and the present invention is not limited thereto. A person of ordinary skill in the technical field to which the present invention pertains may change or modify the described embodiments without departing from the scope of the present invention, and various modifications and variations are possible within the scope of equivalence of the technical idea of the present invention and the scope of the patent claims described below.

1. A touch detection device configured to perform a method of removing noise, the touch detection device comprising:
a panel comprising a plurality of electrodes regularly arranged in a plurality of rows and columns;
a multiplexer configured to be connected to electrodes corresponding to a plurality of rows for each column through a plurality of data lines; and
a sensor driver configured to detect touch input applied to a specific row through a sensing voltage in a state in which a ground potential or a driving voltage having a waveform of a specific cycle is applied to rows adjacent to the specific row,
wherein a specific number of data lines is arranged in a lower region of an electrode at lower left where the sensing voltage is detected among the electrodes, and
the driving voltage or the ground potential is applied to the specific number of data lines through a compensation pattern differently from other data lines.

2. The touch detection device according to claim 1, wherein the sensor driver comprises:
a digital-to-analog converter (DAC) configured to convert a digital signal into an analog signal; and
a repair switch configured to block electrical connection between the DAC and specific data lines when a short circuit occurs in the specific data lines, and
the specific number of data lines is connected to pins of the repair switch.

3. The touch detection device according to claim 2, wherein the sensor driver is configured to:
apply the sensing voltage to the electrode at the lower left, and
control the repair switch so that the driving voltage or the ground potential is applied to the specific number of data lines.

4. The touch detection device according to claim 3, wherein:
the sensor driver further comprises a driving voltage controller configured to apply the driving voltage to some of the specific number of data lines to form a symmetrical electromagnetic distribution based on the electrode at the lower left,
the specific number of data lines is connected to the driving voltage controller so that the driving voltage is applied to first and second lines among the specific number of data lines, and
the specific number of data lines is connected to the ground through the repair switch and the compensation pattern so that the ground potential is applied to a third line among the specific number of data lines.

5. The touch detection device according to claim 4, wherein:
the specific number of data lines in the lower region of the electrode at the lower left is set to three or five, and
the three or five data lines are connected to the driving voltage controller or connected to the ground via the compensation pattern.

6. The touch detection device according to claim 4, wherein the sensor driver is configured to:
acquire data voltages converted into an analog signal form through the DAC, and
connect two lines among three data lines to the driving voltage controller and perform a control operation so that a last line among the three data lines is connected to the ground through the compensation pattern when a data voltage corresponding to the electrode at the lower left is greater than or equal to a reference value.

7. The touch detection device according to claim 6, wherein sensor driver is configured to:
acquire data voltages converted into an analog signal form through the DAC in a state in which the three data lines are connected to the driving voltage controller or the ground, and
perform a control operation so that, when the data voltage corresponding to the electrode at the lower left is greater than or equal to a second reference value, two lines adjacent to the electrode at the lower left among five data lines are connected to the driving voltage controller, and three remaining lines are connected to the ground through the compensation pattern.

8. The touch detection device according to claim 4, wherein the sensor driver is configured to:
apply a sensing signal to a specific row on left as the sensing voltage and apply the sensing signal and reverse signals of a reverse phase to rows adjacent to the specific row as the driving voltage,
perform a control operation so that three or five data lines in the lower region of the electrode at the lower left are connected to the driving voltage controller or connected to the ground through the compensation pattern,
store reverse phase touch coordinate values and potential values at which a potential value greater than or equal a reference value is detected when the potential value greater than or equal to the reference value is detected in rows to which the reverse signals are applied,
determine whether the reverse phase touch coordinate values are included in detected general touch coordinate values while changing rows to which the sensing signal is applied, and
determine touch input for rows corresponding to the reverse phase touch coordinate values to be floating touch input when the reverse phase touch coordinate values are included in the general touch coordinate values.

9. The touch detection device according to claim 8, wherein the sensor driver is configured to:
apply the ground potential to remaining rows outside of the adjacent rows in a state in which the sensing signal and the reverse signals are applied, and
apply a reverse voltage of a reverse phase to the specific row in a column adjacent to a column to which the sensing signal is applied and to the adjacent rows.
